(19) United States
(12) Patent Application Publication
(10) Pub. No.: US 2005/0165723 A1
(43) Pub. Date: Jul. 28, 2005

(54) System and method for database management

(76) Inventors: Yuki Sugimoto, Sagamihara (JP); Yukio Nakano, Oyama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/886,633

(22) Filed: Jul. 9, 2004

(30) Foreign Application Priority Data
Jan. 23, 2004 (JP) 2004-015112

(51) Int. Cl. G06F 7/00

(52) U.S. Cl. 707/1

(57) ABSTRACT

A database management system includes a status analysis processing unit to execute status analysis processing; a reorganization timing estimation processing unit to estimate a future reorganization timing based on data obtained from the status analysis processing unit; a storage status calculation processing unit to calculate a current storage status based on data operation information; a comparison unit to compare the current storage status estimated by the reorganization timing estimation processing unit and the current storage status calculated by the current storage status calculation processing unit; and a reorganization timing re-estimation processing unit to estimate again the future reorganization timing based on the result of the comparison unit.

### CROSS-REFERENCE TO RELATED APPLICATION

This application relates to U.S. patent application Ser. No. 10/377,950 filed on Feb. 28, 2003 assigned to the present assignee. The content of the application is incorporated herein by reference.

The present application claims priority from Japanese application JP 2004-015112 filed on Jan. 23, 2004, the content of which is hereby incorporated by reference into this application.

### BACKGROUND OF THE INVENTION

The present invention relates to a database management system (DBMS).

In a database management system, as it continues processing transactions, data is repetitively inserted, deleted and updated, resulting in stored data being fragmented or disorganized, which in turn causes system performance degradations. It is therefore necessary to periodically perform reorganization on storage areas to eliminate a disturbed storage state by moving stored data to appropriate locations.

A common method of reorganization involves retrieving all the data from the storage areas and then restoring them to eliminate the disorganized state. This method normally requires stopping access to all data in the storage areas being reorganized and thus cannot be executed frequently.

Further, as disclosed in JP-A-6-67950, there is a method which allows access to data in the storage areas during the process of reorganization by making a copy of data and performing reorganization on the copied data. However, this method also is required to perform operations at the end of the reorganization which affect the performance of the online transactions or take long to execute, such as reflecting transactions issued during the reorganization. The use of this technique therefore does not allow the reorganization to be executed frequently.

To deal with this problem it has been a common practice for a DBMS administrator to estimate, prior to database operation, how much a storage state in the database is degraded by transactions and to execute reorganization periodically according to the estimation.

The database storage state deteriorates as the total number of transactions processed increases. In a database operation that performs reorganization periodically, if the amount of transactions to be processed increases sharply, as when an increase in the number of users exceeds an estimation, a performance degradation results before the disorganized state can be eliminated by reorganization. Further, a wrong estimation prior to operation also causes a performance degradation when an increase in the amount of transactions exceeds the estimation. When on the other hand the amount of transactions does not increase as expected, a problem arises that the reorganization is executed more than necessary. Excess reorganizations will lead to an increase in management cost due to an increased labor on the part of the administrator who is required to perform frequent reorganizations and also to a degraded performance due to the load arising from data moving during the reorganization.

To avoid the performance degradation and the execution of excess reorganizations, a decision needs to be made as to whether or not the database must be reorganized. This in turn requires a status analysis to analyze how data is arranged in the storage areas.

This status analysis, since it accesses all data stored, puts a heavy load on the DBMS and thus cannot be executed frequently. To cope with this problem, a method for making a judgment as to the necessity of reorganization according to access speeds during queries without performing the status analysis is disclosed in U.S. Pat. No. 5,596,747. A flow of processing in this method is shown in FIG. 20.

When it receives a data operation (step 2001), the DBMS checks an access speed for that data operation (step 2002), makes a decision on reorganization based on the access speed found (step 2003) and, if it is decided that it is time for reorganization, produces an output indicating that it is time to execute reorganization (step 2004). If it is not time for reorganization, the database operation is allowed to continue (step 2005).

The administrator waits for a reorganization trigger to be output (step 2009), determines an execution timing from a reorganization executable period (step 2010) and executes the reorganization accordingly (step 2011).

However, because the reorganization arranges data in an ordered manner, it entails a system shutdown or places a heavy load on the system. So, the reorganization needs to be executed by estimating a time band when the amount of transactions decreases and making an appropriate plan.

With the method of JP-A-6-67950, since a check is made of the current state at all times to see if the reorganization is currently required or not, there is no way of knowing in advance when the reorganization will be required, making scheduled reorganizations impossible. Hence, in a database operation such as shown in FIG. 20, if a situation is encountered where reorganization is required, the following problems will arise: the DBMS will be heavily burdened by the execution of reorganization at a time when many transactions occur or the DBMS will be forced to continue its operation at a degraded performance without executing the reorganization.

### SUMMARY OF THE INVENTION

In light of the above drawback it is an object of this invention to enable the user to plan an execution of reorganization at an appropriate time in future by estimating with high precision a timing when the reorganization will become necessary.

To achieve the above objective, the present invention provides a database management system which manages database storage areas in an external storage device and which performs reorganization processing for eliminating disturbances in the storage state of data caused by inserts and deletes performed on the storage areas of database and status analysis processing for analyzing a storage efficiency and the number of fragmented data to see how data is arranged in the storage areas. The database management system has: a storage status disturbance factor list; a disturbance decision threshold list containing thresholds against which a magnitude of each of the disturbance factors is checked to determine if the reorganization processing is necessary; and a warning output threshold list containing thresholds used to determine whether or not to issue a warning that there is a large difference between an actual storage state and an estimated storage state. In this database management system, this invention also provides a database reorganization timing estimation method which includes the steps of:
storing a result of the status analysis processing in a status analysis result log;
performing reorganization timing estimation processing to estimate a time when the disturbance decision threshold is exceeded, from a transition of the status analysis result log;
assuming, from a result of the reorganization timing estimation and the status analysis result log, a transition of a storage status value representing a storage state from when the status analysis was executed to a future point in time represented by the reorganization timing estimated result;
determining from the transition of the storage status value a storage status estimated value representing an estimate of a current storage status value when a data operation that modifies data in the storage areas is executed;
calculating an accumulated value of changes in the storage status value caused by data operations;
calculating a current storage status represented by the current storage status value from the status analysis result log and the accumulated value of changes; and
comparing the current storage status with the storage status estimated value and, when their ratio is in excess of the warning output threshold, executing the reorganization timing estimation again and outputting a corrected, estimated result.

A flow of processing in this case is shown in FIG. 21.

Upon receiving a status analysis command (step 2101), the DBMS stores a result of the status analysis as a status analysis result log (step 2102) and estimates a reorganization timing by using the log (step 2103). Then, when it receives a data operation command (step 2104), the DBMS calculates a change in the storage status caused by the data operation (step 2105) and outputs an estimation whose precision is enhanced by taking the storage status change into account (step 2106).

After the DBMS is started, an administrator performs a status analysis (step 2112), thereafter checks the reorganization timing estimated result output from the DBMS (step 2113) and executes the reorganization when the estimated timing is reached (step 2107).

Next, by referring to FIG. 23, we will explain a configuration of the reorganization timing estimation function of the database system of this invention.

To execute reorganization processing in the database stored in an external storage device 205 connected to a computer system 201 via network, the computer system 201 of FIG. 23 has the following processing units:

A status analysis unit 2300 to execute a status analysis processing; a reorganization timing estimation unit 2301 to estimate a future reorganization timing based on data from the status analysis unit; a storage state calculation unit 2302 to calculate a current storage state based on data operation information; a comparison unit 2303 to compare the current storage state estimated by the reorganization timing estimation unit and the current storage state calculated by the storage state calculation unit; and a reorganization timing re-estimation unit 2304 to estimate again the reorganization timing according to a result of the comparison unit.

Other objects, features and advantages of the invention will become apparent from the following description of the embodiments of the invention taken in conjunction with the accompanying drawings.

### BRIEF DESCRIPTION OF THE DRAWINGS

FIG. 1 shows entire processing performed in the present invention.

FIG. 2 shows a configuration of a database management system that embodies the present invention.

FIG. 3 shows an outline flow of storage status change calculation processing in this embodiment.

FIG. 4 shows an outline flow of current storage status calculation processing in this embodiment.

FIG. 5 shows an outline flow of comparison processing to compare the current storage status with an estimated value in this embodiment.

FIG. 6 shows entire processing performed in the present invention.

FIG. 7 shows a configuration of a database management system that embodies the present invention.

FIG. 8 shows an outline flow of a next status analysis execution recommended timing indication processing according to this embodiment.

FIG. 9 is an outline flow of a past log management processing according to this embodiment.

FIG. 10 is an outline flow of an estimated reorganization timing correction processing according to this embodiment.

FIG. 11 shows a configuration of a database management system that embodies the present invention.

FIG. 12 shows entire processing performed in the present invention.

FIG. 13 shows a configuration of a database management system that embodies the present invention.

FIG. 14 is a list of current storage status assumed values.

FIG. 15 is a status analysis result log.

FIG. 16 is a reorganization timing estimated result.

FIG. 17 is a list of warning output thresholds for outputting a warning that there is a large difference between the storage status and the estimated status.

FIG. 18 is a list of disturbance decision thresholds used to decided whether the storage status is disturbed.

FIG. 19 is a reorganization execution log.

FIG. 20 is an outline flow of conventional processing.

FIG. 21 is an outline flow of a resolving means according to this invention.

FIG. 22 is a log transition tendency indicating how the disturbance value has changed.

FIG. 23 is a diagram showing a configuration of an example reorganization timing estimation device according to this invention.

FIG. 24 is a diagram showing an example display screen in a system applying this invention, on which a warning about reorganization is shown to alert an administrator managing the reorganization timing.

### DETAILED DESCRIPTION OF EMBODIMENTS

### 1. First Embodiment

A first embodiment of this invention will be described.

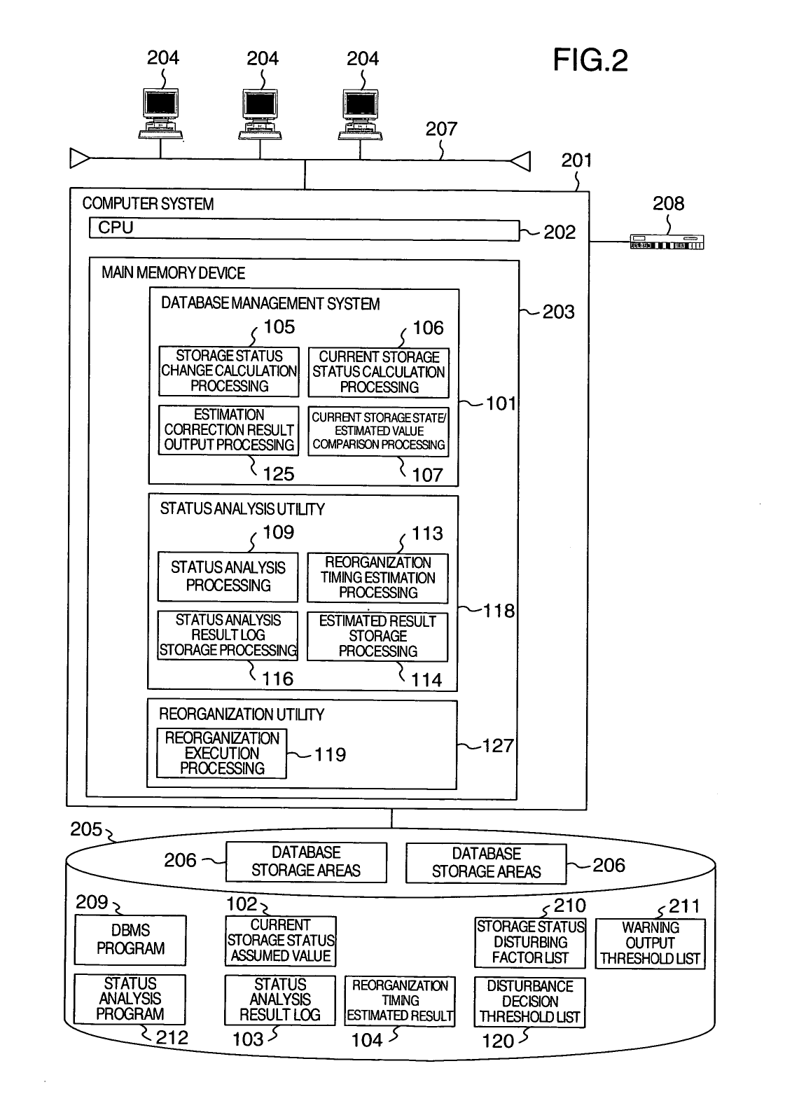

FIG. 2 shows an example configuration of a computer system of this embodiment.

A computer system 201 includes a CPU 202, a main memory device 203, an external storage device 205, such as a magnetic disk drive, and a flexible disk drive 208, and is connected to many terminals 204 via a network 207. On the main memory device 203 are located a database management system 101 and a status analysis utility 118. On the external storage device 205 are placed database storage areas 206 for storing databases managed by the database management system 101.

The external storage device 205 stores a program 209 to implement the database management system 101, a program 212 to implement the status analysis utility 118, a current storage status assumed value 102 used by these programs, a status analysis result log 103, a reorganization timing estimated result 104, a storage status disturbing factor list 210, a disturbance decision threshold list 120, and a warning output threshold list 211.

The programs stored in the external storage device 205 are loaded into the main memory device 203 and then the CPU 202 analyzes the programs to run the database management system 101 and the status analysis utility 118.

The terminals 204 are used to operate, via the network 207, the database management system 101, enter a status analysis command to execute the status analysis utility 118, make a request for executing a query, which is a data operation that makes changes to data in the storage areas, and output data. In the explanation of the processing flow, queries are referred to as SQLs. The programs in the external storage device 205 may also be provided in an external, portable drive or through the network 207.

The storage status disturbing factor list 210 is a list of factors contributing to a disorganized storage state, prepared beforehand in the DBMS. This list consists of the following two items:

A storage efficiency of used areas: a ratio of a real volume of data stored to a maximum volume of data that can be stored in the database storage areas being used. Repetitive execution of inserts and deletes on the database results in empty areas being scattered in the currently used storage areas, causing a storage efficiency degradation.

The number of forwarded rows: in a state in which a single row is divided into fragments that are stored in different pages, each page constituting a unit of data when data is written into or read from the storage areas; the number of fragmented rows that occur when a row becomes longer than the original after an update operation.

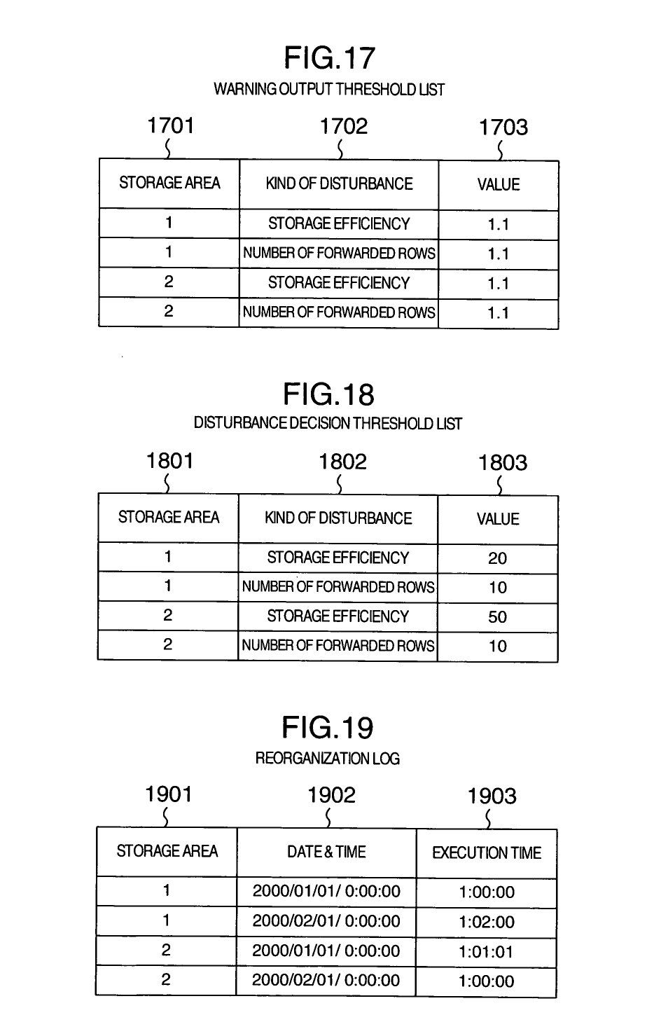

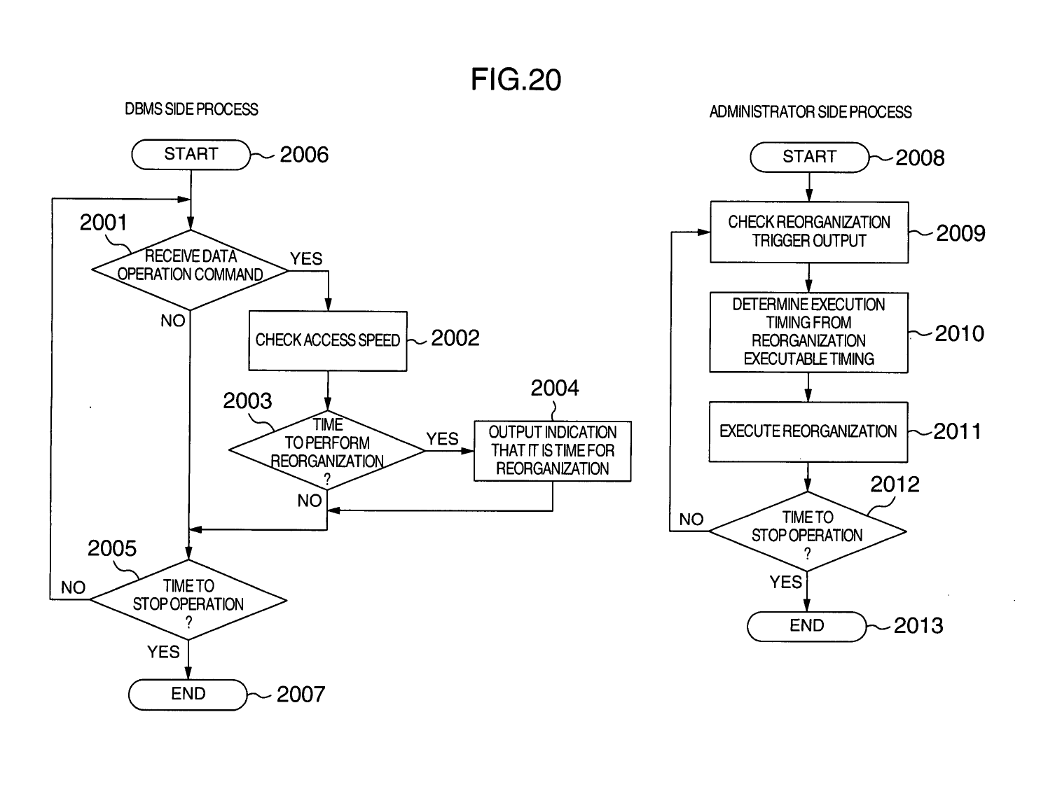

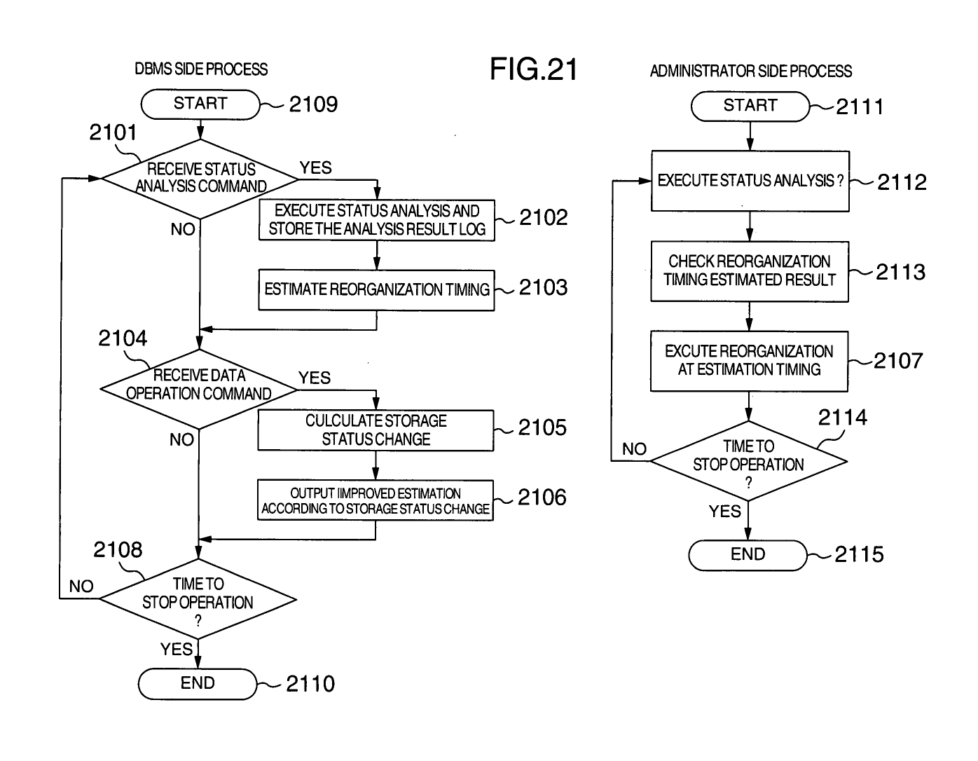

The warning output threshold list 211 is a list of thresholds indicating how far the storage state must deviate from the estimation before the warning is issued. A default value is prepared in advance in the DBMS but the user may specify a desired value. The list comprises a stored area, a kind of disturbance and a threshold value, as shown in FIG. 17.

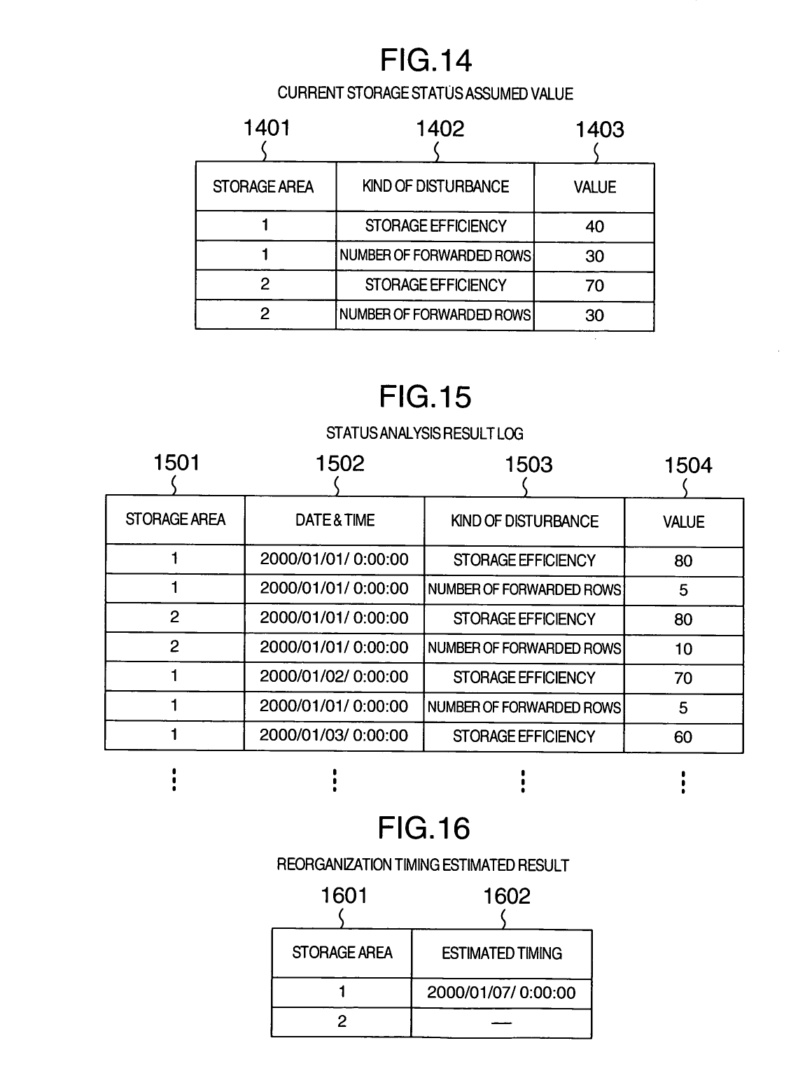

The current storage status assumed value 102 indicates changes in the storage efficiency of used areas and the number of forwarded rows which have resulted from executing SQL statements. This list consists of a stored area, a kind of disturbance and an amount of change in the storage state value, as shown in FIG. 14.

The status analysis result log 103 is a log of results obtained by executing the status analyses. This list consists of a stored area, a date and time, a kind of disturbance and a value obtained by status analysis, as shown in FIG. 15.

The reorganization timing estimated result 104 is a result of executing a reorganization timing estimation processing 113 which, based on transitions of the status analysis result log 103, predicts when the reorganization will become necessary. This list, as shown in FIG. 16, has a stored area and an estimated time when that area will require reorganization.

The disturbance decision threshold list 120 is a list of values at which reorganization becomes necessary. Although default values are prepared in advance in the DBMS, the user may specify desired values. This list has a stored area, a kind of disturbance and a disturbance decision threshold, as shown in FIG. 18.

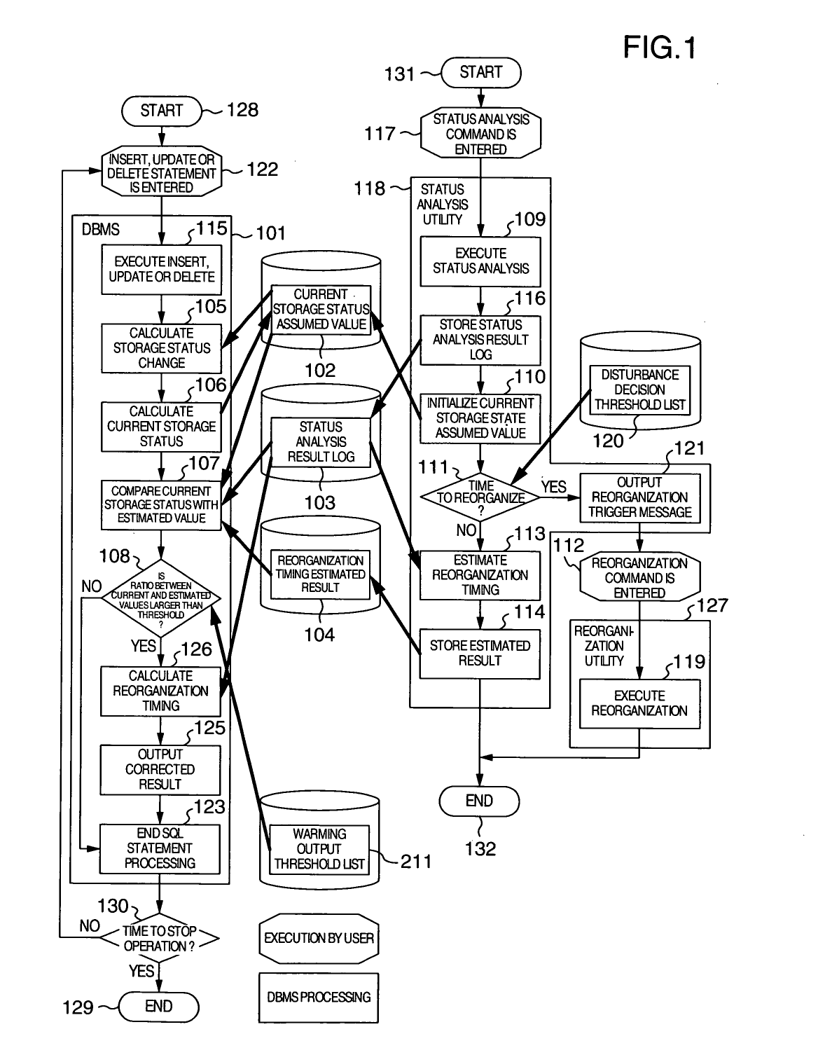

FIG. 1 shows an entire processing flow in this invention. The processing performed by the DBMS, the status analysis utility and a reorganization utility will be explained individually.

Generally, a DBMS administrator enters commands from the terminal 204 of FIG. 2 (step 117) to cause the DBMS to execute the status analysis utility and the reorganization utility. Normally, SQL statement transactions are issued from other business applications. It is also possible to issue SQL transactions from the terminal 204 for their execution by the DBMS.

The flow of processing performed by the status analysis utility 118 is as follows.

Upon receiving a status analysis command (step 117), the status analysis utility reads data from the storage area and executes a status analysis processing to determine the storage efficiency of used areas and the number of forwarded rows (step 109). The utility stores the status analysis result obtained and the time in the status analysis result log 103 (step 116) and then initializes the current storage status assumed value 102 with the value of the status analysis result (step 110).

Next, based on the status analysis execution result and the disturbance decision threshold list 120, the utility determines if it is necessary to perform reorganization according to whether the value obtained from the status analysis exceeds the disturbance decision threshold (step 111). If it is decided that it is time to perform reorganization, the utility outputs a reorganization trigger message (step 121). When the message is output, the user enters a reorganization command (step 112) to initiate the reorganization utility.

The reorganization utility, as shown in FIG. 1, executes the reorganization processing (step 119).

If it is found that it is not time to perform reorganization, the status analysis utility executes the reorganization timing estimation processing (step 113) to calculate, based on the transitions of the status analysis result log 103, a time in the future when the disturbance threshold will be exceeded, in order to predict when the reorganization will become necessary.

The status analysis result log of FIG. 15 is plotted on a graph for each of the used areas 1501 and the kind of disturbance 1503, with the date and time on an X-axis and values 1504 on a Y-axis. The method of least squares is used to predict from the graph a point in time at which the disturbance decision threshold value 1803 of FIG. 18 will be reached. Take the storage area 1 of FIG. 15 for example. Pairs of the date and time and the threshold value for this storage area are (2000/01/01 0:00:00, 80), (2000/01/02 0:00:00, 70) and (2000/01/03 0:00:00, 60), and it is estimated by the linear prediction that the threshold value of 20 in FIG. 18 will be exceeded at 2000/01/07 0:00:00. So, the estimated timing for the storage area 1 is 2000/01/07 0:00:00, as shown in FIG. 16. At this time, since the number of forwarded rows does not change, it is not used for the estimation. As for the storage area 2, the estimation is not performed because there is not enough log.

The result thus obtained is output to the reorganization timing estimated result 104 where it is saved (step 114).

Now, a flow of processing of SQL statements in the database management system 101 that affect the storage status, such as insert, delete and update, will be described.

When an SQL statement that will cause a change to the storage status is received (step 122), the DBMS executes a transaction specified by the SQL statement (step 115) and then executes a storage status change calculation processing that calculates an amount of change in the storage status disturbance based on the result of the transaction (step 105).

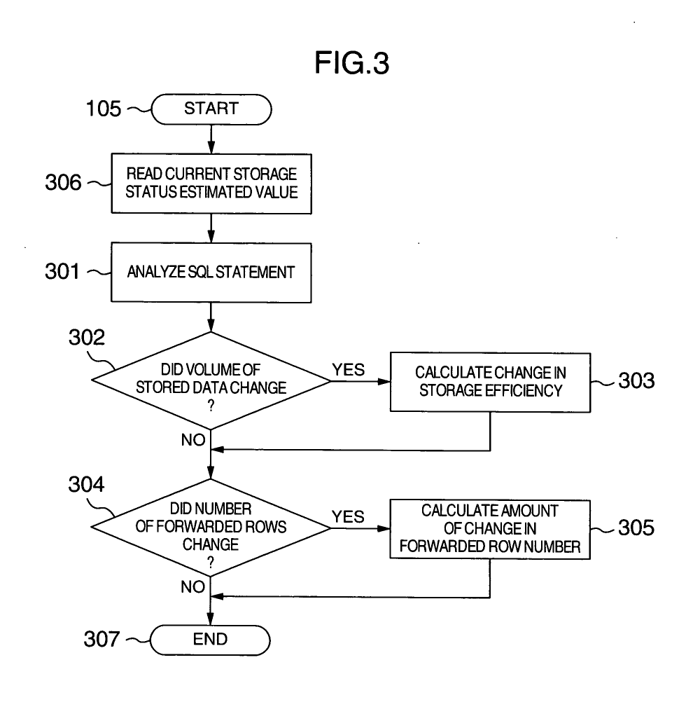

A flow of the storage status change calculation processing 105 is shown in FIG. 3.

This process reads the current storage status assumed value 102 (step 306) and then, from information obtained by executing the SQL statement, analyzes what insert, delete, etc. has done, by how much the length of row is increased or decreased, and whether forwarded rows are produced (step 301).

This analysis checks if the volume of data has changed (step 302). If it is found that the data volume has changed, an amount of change in storage efficiency is calculated from the data volume change and the capacity of storage area currently used (step 303). For example, consider a case where an insert statement is used. The length of an inserted row is checked and added to the current total volume of stored data obtained from the current storage status assumed value 102 to recalculate the storage efficiency.

A further check is made by the analysis to see if forwarded rows are produced or deleted (step 304) and the number of these forwarded rows are counted to calculate the amount of change in the number of forwarded rows (step 305).

Returning to the flow of FIG. 1, the current storage state is calculated from the current storage status assumed value 102 and the status analysis result log 103 (step 106).

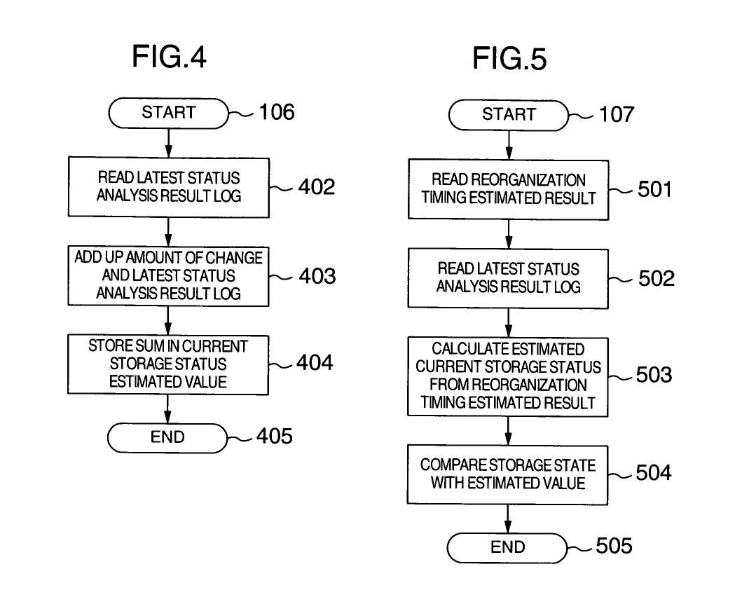

A flow of current storage status calculation processing 106 is shown in FIG. 4.

The latest of the status analysis result log 103 is read (step 402). To this is added the result obtained by the storage status change calculation processing 105 (step 403), and the sum is stored in the current storage status assumed value 102 (step 404).

Returning to the flow of FIG. 1, the current storage status is compared with the estimated value of the current storage status obtained from the reorganization timing estimated result 104 (step 107).

A flow of comparison processing 107 to compare the current storage state with the estimated value is shown in FIG. 5.

The reorganization timing estimated result 104 is read (step 501).

The latest of the status analysis result log 103 is read (step 502).

An estimated value of the current storage status is calculated from the reorganization timing estimated result 104 and the status analysis result log 103 (step 503) and compared with the current storage status assumed value 102 to obtain their ratio (step 504).

Returning to the flow of FIG. 1, if the calculated ratio is greater than the threshold of the warning output threshold list 211 (step 108), this indicates that the estimation is wrong. So, reorganization timing estimation processing 126 is executed, based on the current storage state and the status analysis result log 103 and the estimated result is output (step 125).

In the case of the storage efficiency for storage area 1 in the current storage status assumed value 102 of FIG. 14, for example, let us assume that the current storage status assumed value is 40 and the current time is 2000/01/04 0:00:00. Then, from the status analysis result log 103 of FIG. 15 it is estimated that the storage efficiency will be 50 at 2000/01/04 0:00:00. This ratio is 50/40=1.25, which is higher than the value of 1.1 in the warning output threshold list 211 of FIG. 17. Thus, a warning is issued and a re-estimation is prompted.

With the above steps, the processing of SQL statement is ended (step 123).

The above is the description of the first embodiment of this invention.

With this embodiment, by checking how the storage status has changed when SQL statements that cause changes to the storage status, such as insert, update and delete, are processed, the current storage status can be calculated without performing the status analysis after the status analysis has been performed once to make an estimation.

As a result, when a rate of increase in the storage status disturbance has risen significantly, it is possible to detect a change in the rate of increase, correct the estimated result of reorganization timing according to that change and output the corrected result. Further, when a change in the rate of disturbance increase is detected, only a warning may be output and the user may execute the status analysis to correct the reorganization timing. Thus, after the estimation was made by performing the status analysis several times during the system operation, the user needs only to check the estimated reorganization timing displayed as it is calculated and to plan the reorganization accordingly. This allows the user to perform scheduled reorganizations.

### 2. Second Embodiment

Next, a second embodiment of this invention will be described.

Unlike the first embodiment, the second embodiment does not perform the status analysis frequently but performs it only at the start of the DBMS and thereafter estimates the reorganization timing and makes a decision on the reorganization trigger, based only on storage status changes resulting from query processing.

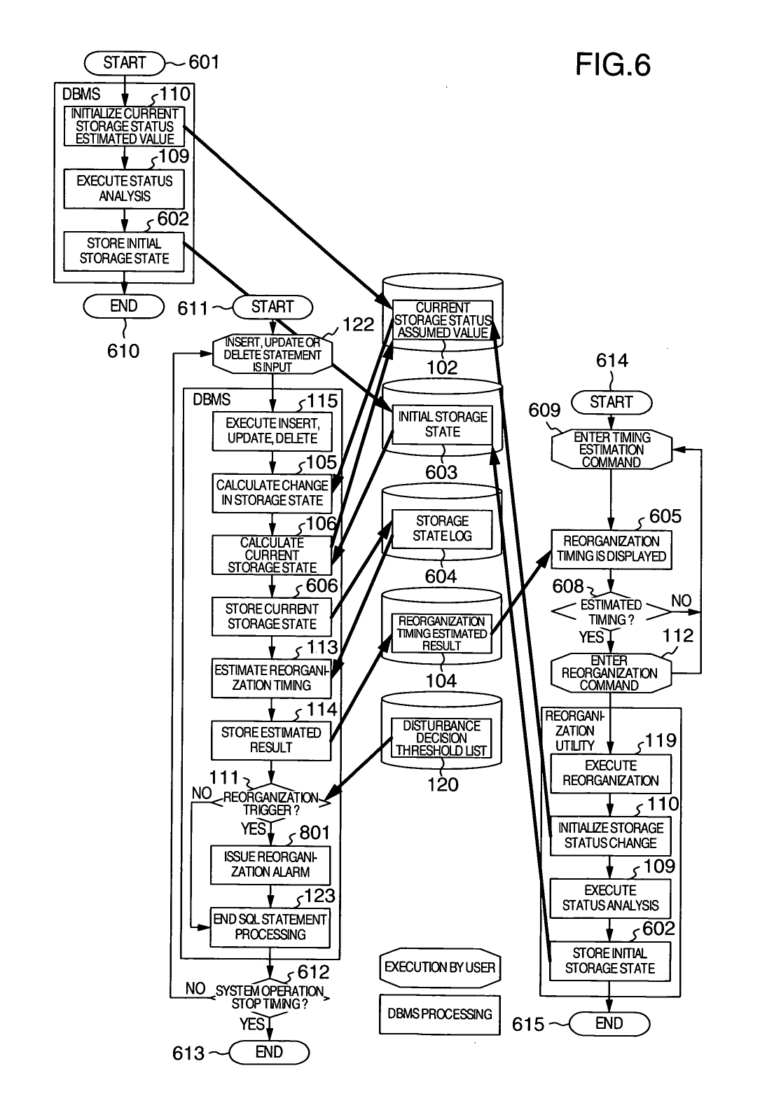

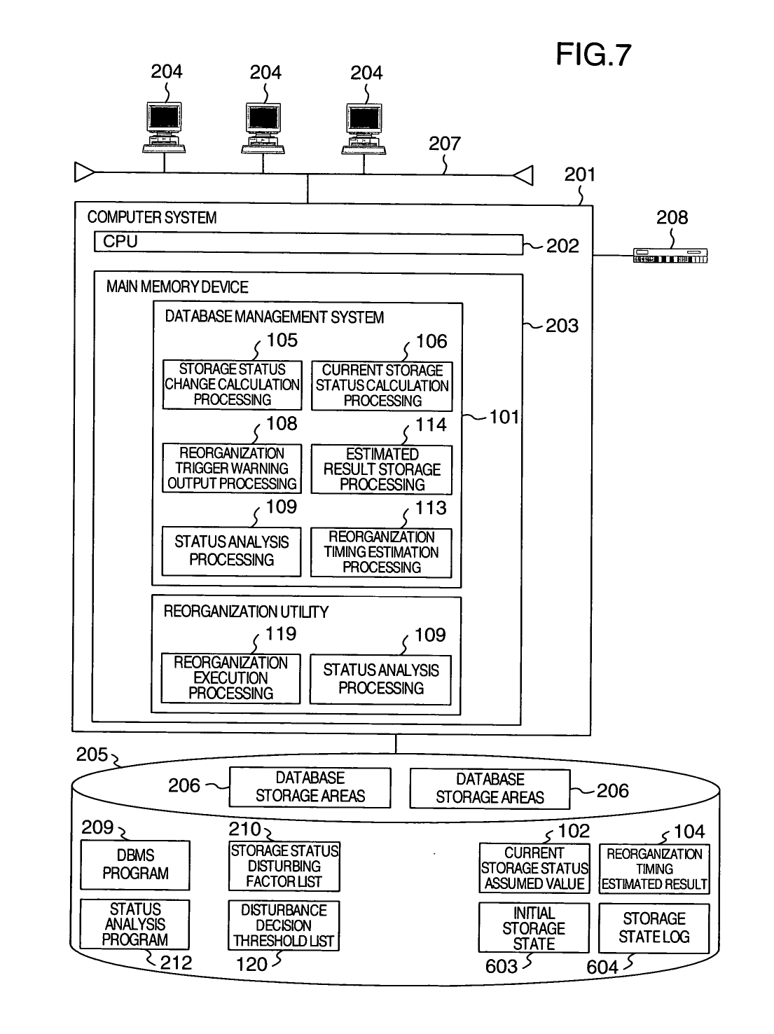

An overall processing flow in this method is shown in FIG. 6 and an example configuration of a computer system of this embodiment in FIG. 7. This configuration is similar to that of the first embodiment except that the status analysis utility is omitted and that the status analysis is included in the DBMS and in the reorganization utility.

At the start of the DBMS (step 601), this processing initializes the current storage status assumed value 102 (step 110), executes the status analysis (step 109) and stores the analysis result in an initial storage state 603 (step 602).

When an SQL transaction that causes a change to the storage status, such as insert, delete and update, is received (step 122), the DBMS processes the transaction specified by the SQL statement (step 115) and calculates, from the content of transaction, an amount of change in the storage state disturbance (step 105). This processing is the same as the flow shown in FIG. 3.

Next, from the current storage status assumed value 102 and the initial storage state 603, the current storage state is calculated (step 106). This is similar to the flow shown in FIG. 4.

The current storage state thus obtained is saved as a storage state log 604 (step 606) and the reorganization timing is estimated by using the stored log (step 113). The estimated result is stored as the reorganization timing estimated result 104 (step 114).

From the current storage state thus obtained and the disturbance decision threshold list 120, a check is made as to whether the current storage state has become a reorganization trigger (step 111). If so, a warning is issued to alert that the reorganization processing is required (step 801).

With the above steps, the SQL processing is ended (step 123).

The initial storage state 603 and the storage state log 604 have the same format as the status analysis result log 103 of FIG. 15.

The user enters a timing estimation command (step 609) that displays the reorganization timing estimated result 104, in order to check the estimation timing. When the estimated timing arrives (step 608), the user enters a reorganization command (step 112).

Then, the DBMS initializes the current storage status assumed value 102, executes the status analysis (step 109) and stores the analysis result in the initial storage state 603 (step 602).

The second embodiment has been described above.

This embodiment allows the reorganization timing to be estimated according to the processing of SQL transactions, without executing the status analysis, so that, with only the internal processing in the DBMS, the user is able to know when to perform the reorganization. It is also possible to issue an alert when the estimated timing draws near.

### 3. Third Embodiment

Next, a third embodiment of this invention will be described.

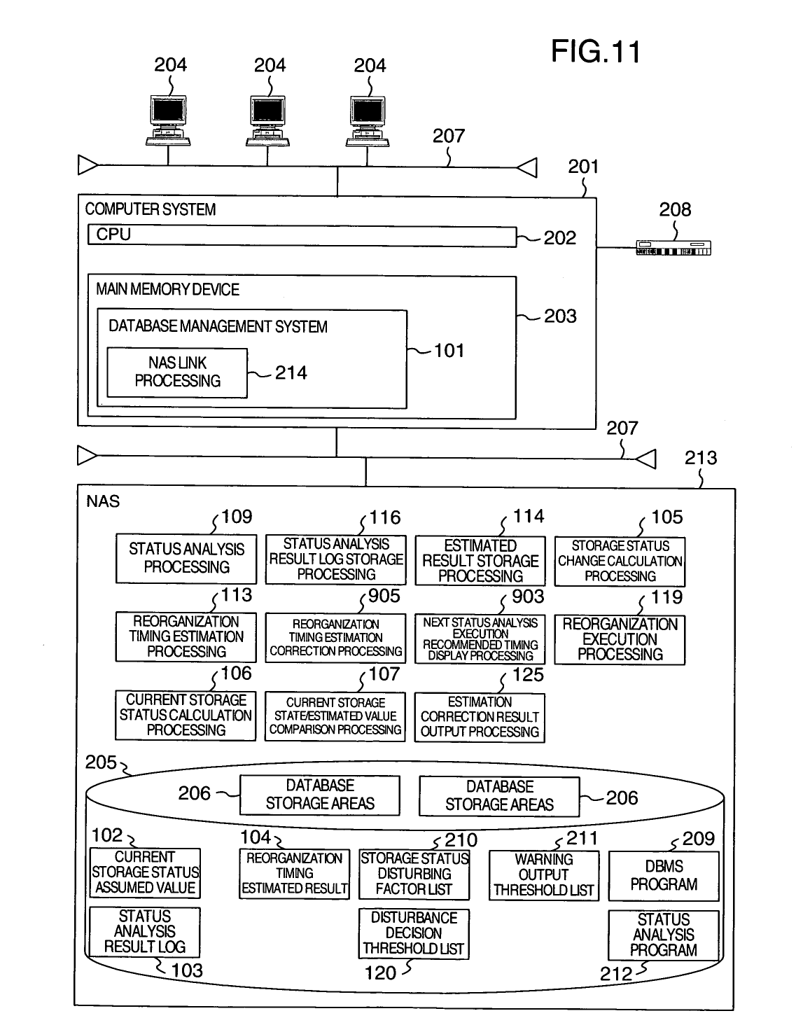

FIG. 11 shows an example configuration of a computer system of this embodiment.

In this embodiment all the external storage devices 205 are managed by NAS (Network Attached Storage) 213, which executes all processing that was performed in the database management system 101, i.e., status analysis processing 109, status analysis result log storage processing 116, estimated result storage processing 114, storage status change calculation processing 105, reorganization timing estimation processing 113, estimated reorganization timing correction processing 905, next status analysis execution recommended timing indication 903, current storage status calculation processing 106, current storage state/estimated value comparison processing 107 and estimation correction result output processing 125.

In this case, to establish a link between the database management system 101 and the NAS 213, an NAS link processing 214 is necessary.

This processing is the same as in the first embodiment.

This embodiment therefore allows the user to plan in advance the execution of reorganization at an appropriate time in future even in an environment where all the external storage devices 205 are managed by the NAS.

### 4. Fourth Embodiment

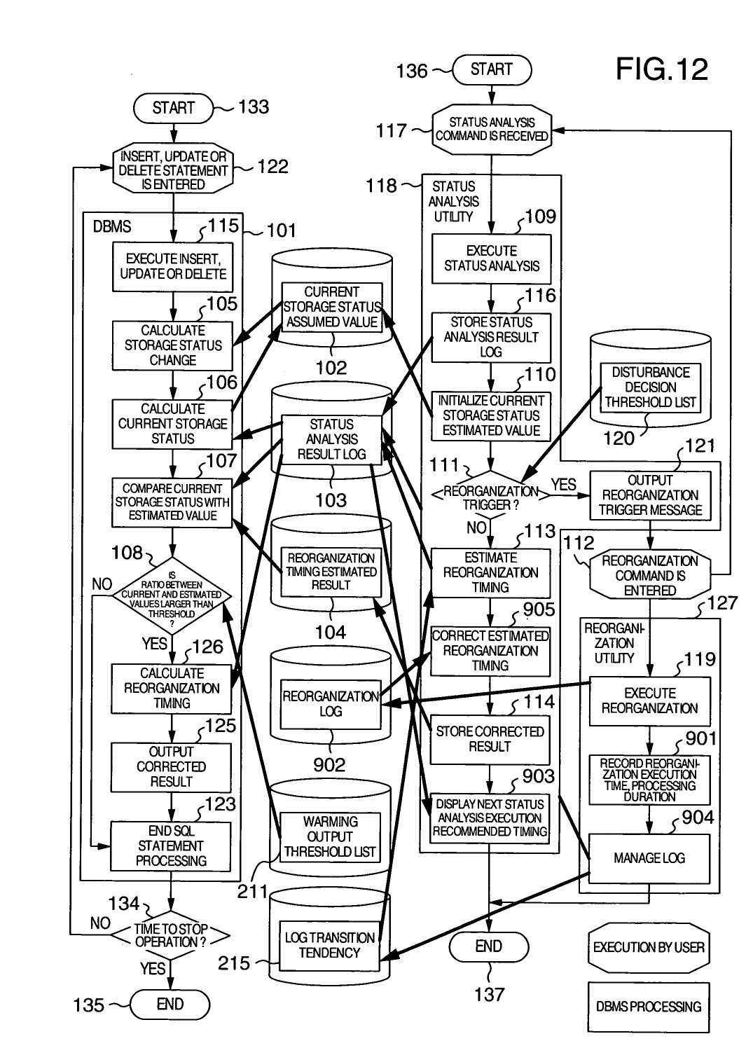

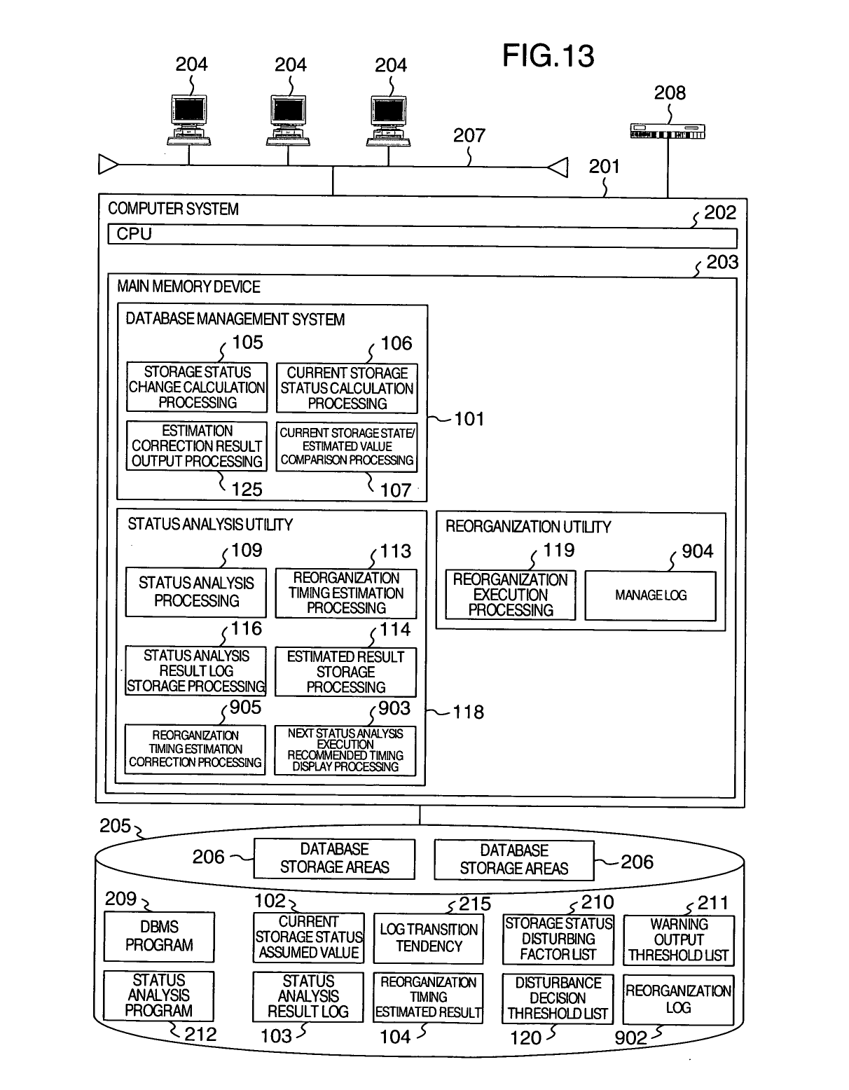

An entire processing flow in this method is shown in FIG. 12 and an example configuration of the computer system of this embodiment in FIG. 13. This embodiment has, in addition to the processing in the first embodiment, a correction of reorganization estimated timing according to the reorganization execution timing, an indication of next status analysis execution recommended time and a log management at time of reorganization execution.

A flow of processing performed by the status analysis utility 118 is as follows.

When a status analysis command is received (step 117), the utility reads data from the storage area and performs the status analysis using the storage status disturbing factor list 210 to determine the storage efficiency of used areas and the number of branched rows (step 109). The status analysis result thus obtained and the time are stored in the status analysis result log 103 (step 116). Then the current storage status assumed value 102 is initialized (step 110). Next, based on the status analysis execution result and the disturbance decision threshold list 120, the utility determines if it is necessary to perform reorganization according to whether the value obtained from the status analysis exceeds the disturbance decision threshold (step 111). If it is decided that it is time to perform reorganization, the utility outputs a reorganization trigger message (step 121). When the message is output, the user enters a reorganization command (step 112) to initiate the reorganization utility.

If it is not time to perform reorganization, the status analysis utility executes the reorganization timing estimation processing (step 113) to calculate, based on the transitions of the status analysis result log 103, a time in the future when the disturbance threshold will be exceeded, in order to predict when the reorganization will become necessary. The estimated reorganization timing correction processing is performed on the estimated timing (step 905).

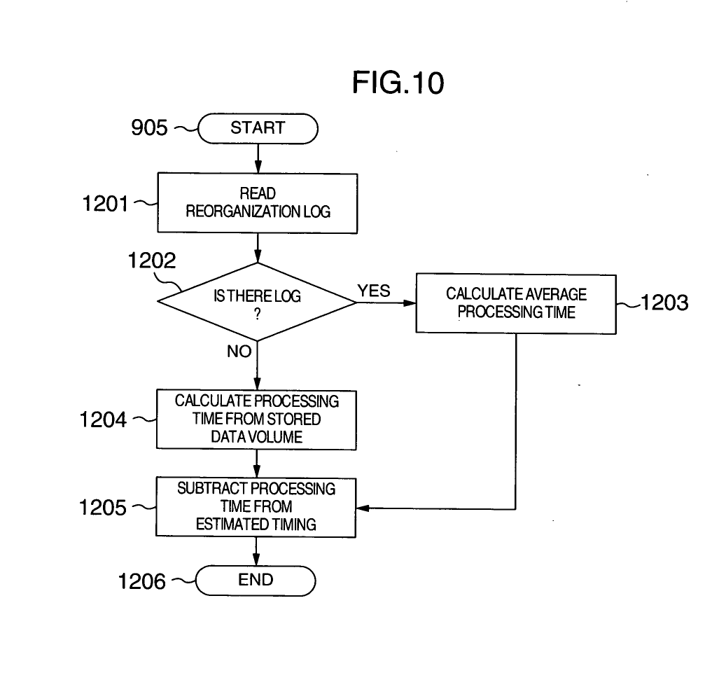

The flow of the estimated reorganization timing correction processing 905 is shown in FIG. 10.

First, the correction processing reads the reorganization log (step 1201) and checks if any reorganization log exists (step 1202). If the log exists, the correction processing calculates an average of the reorganization processing time and subtracts the average processing time from the estimated timing (step 1205).

If there is no reorganization log, the correction processing calculates a time that may be taken by the reorganization, from the stored data volume obtained by the status analysis processing 109 (step 1204) and subtracts the calculated time from the estimated timing (step 1205).

Returning to the flow of FIG. 12, the corrected result obtained from the above correction processing is output to the reorganization timing estimated result 104 where it is stored (step 114). Then, the next status analysis execution recommended timing indication processing is performed (step 903).

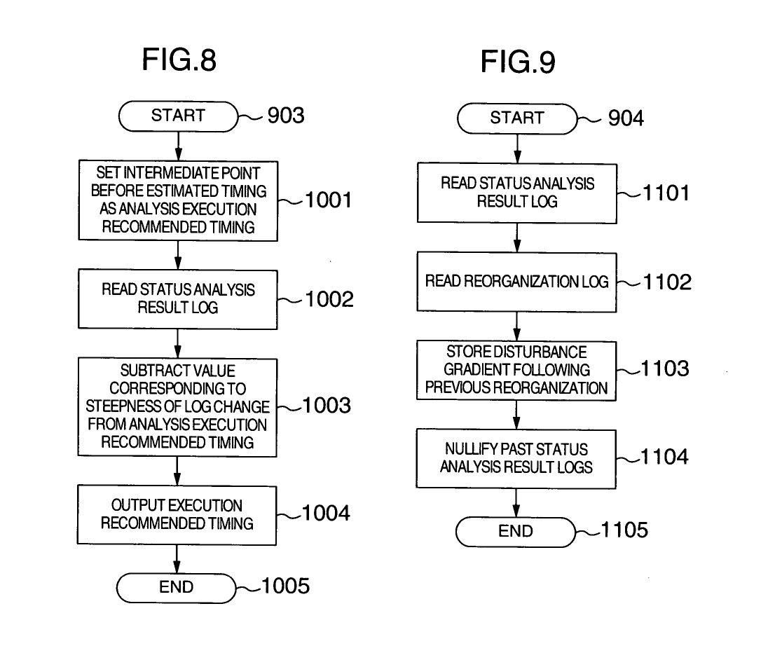

The flow of the next status analysis execution recommended timing indication 903 is shown in FIG. 8.

First, a future point in time before the estimated timing is set as a status analysis execution recommended timing (step 1001).

Next, the recommended timing indication processing reads the status analysis result log (step 1002), subtracts a value proportional to a log gradient from the status analysis execution recommended timing (step 1003) and outputs the resultant status analysis execution recommended timing (step 1004).

At the indicated timing, the user enters the status analysis command again (step 117).

The reorganization utility, as shown in the flow of FIG. 12, executes the reorganization processing (step 119) and records the time taken by the reorganization processing and the execution time in the reorganization log 902 (step 901).

Then the log management processing is executed (904).

The flow of the log management processing 904 is shown in FIG. 9.

The log management processing 904 reads the status analysis result log 103 (step 1101) and the reorganization log 902 (step 1102).

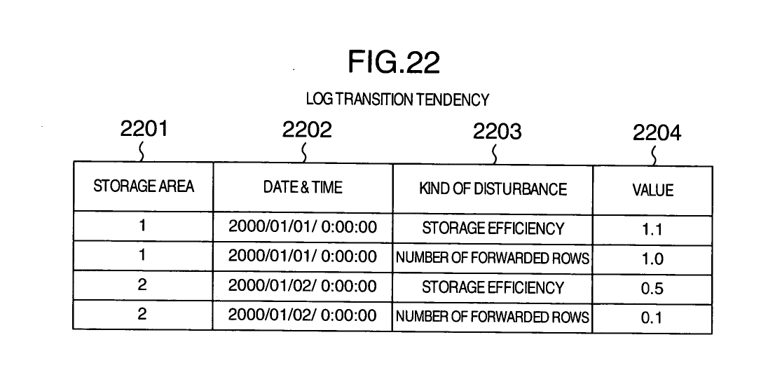

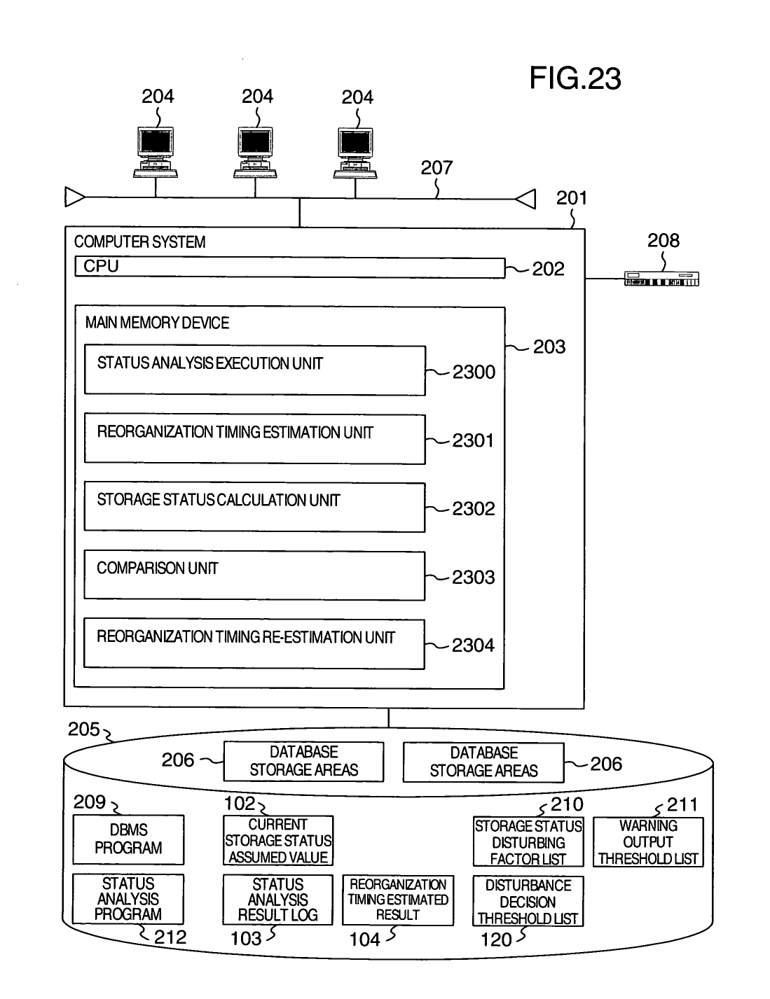

To indicate how a value representing the disturbance has changed from the execution of the previous reorganization up to now, a gradient of the storage state disturbance value obtained by the status analysis is calculated and stored as a log transition tendency 215 (step 1103). This is shown in FIG. 22.

The past status analysis result logs are nullified so that it will not be used for estimation after the reorganization (step 1104).

When the reorganization timing estimation processing 113 is performed, if there is not enough log for estimation because of the nullification of old logs, the gradient of the log transition tendency 215 is used to estimate a time in future when the disturbance decision threshold will be exceeded.

Referring to FIG. 12, a flow of processing of SQL statements that affect the storage state, such as insert, delete and update, as performed in the database management system 101, will be explained.

When an SQL statement that will cause a change to the storage status is received (step 122), the DBMS executes a transaction specified by the SQL statement (step 115) and then executes a storage status change calculation processing that calculates an amount of change in the storage status disturbance based on the result of the transaction (step 105). This flow is the same as that shown is shown in FIG. 3.

Returning to the flow of FIG. 12, the current storage status is calculated (step 106) from the current storage status assumed value 102 obtained by the storage status change calculation processing 105 and from the status analysis result log 103. This flow is similar to that shown in FIG. 4.

In the flow of FIG. 12, a comparison is made between the current storage status and the estimated value of current storage status obtained from the reorganization timing estimated result 104 (step 107).

A flow of the processing 107 for comparing the current storage status and the estimated value is shown in FIG. 5.

The comparison processing reads the reorganization timing estimated result 104 (step 501).

The comparison processing then reads the latest status analysis result log 103 (step 502), calculates an estimated value of the current storage status from the reorganization timing estimated result 104 and the status analysis result log (step 503) and compares the estimated value with the current storage status calculated by the current storage status calculation processing 106 to obtain their ratio (step 504).

Returning to the flow of FIG. 12, if the calculated ratio is greater than the threshold of the warning output threshold list 211 (step 108), this indicates that the estimation is wrong. So, reorganization timing estimation processing 126 is executed by using the current storage state and the status analysis result log 103 and the correct estimation is output (step 125).

With the above steps, the processing of the SQL statements is ended (step 123).

This embodiment therefore makes it possible to obtain a criterion as to when the status analysis should be executed next and to perform a simple estimation immediately after the reorganization is executed.

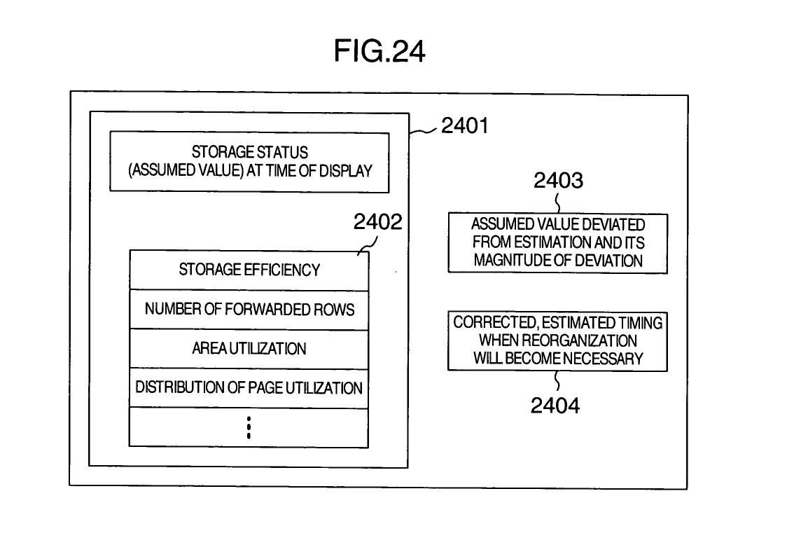

FIG. 24 shows a content of a management monitor which is advantageous for an administrator who manages the reorganization timing estimation in a database management system incorporating the embodiment of the invention.

When the estimation obtained by the reorganization processing is wrong, it is possible to output to a display screen the storage state assumed value 2401 at the current time (including detailed data 2402 such as storage efficiency), an amount of deviation 2403 of the assumed value from the estimated value and the corrected reorganization timing estimation 2404 along with a warning, as shown in FIG. 24. The output of warning therefore allows a high precision estimation to be performed again at any desired time without placing a heavy load on the DBMS whenever the first estimation proves wrong. This in turn provides an advantage of being able to make a high precision estimation.

Although the display of this example shows the above data on a single page, the data may be displayed on divided, different pages. Further, the display screen may include an instruction field in which the user, who manages the reorganization timing, can specify data operations for the execution of the status analysis processing, an output field in which an estimated result of the reorganization timing before correction is output, and a reorganization execution instruction field in which to instruct the database management system to perform reorganization. This arrangement can facilitate the management of the reorganization processing.

Even in an environment where a volume of processing changes sharply, this invention can precisely estimate the timing when the reorganization will become necessary by considering effects of processing volume variations, which in turn allows the user to plan in advance the execution of reorganization at an appropriate time.

It should be further understood by those skilled in the art that although the foregoing description has been made on embodiments of the invention, the invention is not limited thereto and various changes and modifications may be made without departing from the spirit of the invention and the scope of the appended claims.

1. A database management system comprising:
a status analysis processing unit to execute status analysis processing;
a reorganization timing estimation processing unit to estimate a future reorganization timing based on data obtained from the status analysis processing unit;
a current storage status calculation processing unit to calculate a current storage status based on data operation information;
a comparison unit to compare the current storage status estimated by the reorganization timing estimation processing unit and the current storage status calculated by the current storage status calculation processing unit; and
a reorganization timing re-estimation processing unit to estimate again the future reorganization timing based on the result of the comparison unit.

2. A storage system having database storage areas in an external storage device provided separate from and connected to a computer system, estimating a timing for reorganizing the database and controlling the external storage device; the storage system comprising:
a status analysis processing unit to execute status analysis processing;
a reorganization timing estimation processing unit to estimate a future reorganization timing based on data obtained from the status analysis processing unit;
a storage status calculation processing unit to calculate a current storage status based on data operation information;
a comparison unit to compare the current storage status estimated by the reorganization timing estimation processing unit and the current storage status calculated by the current storage status calculation processing unit; and
a reorganization timing re-estimation processing unit to estimate again the future reorganization timing based on the result of the comparison unit.

3. A database management method comprising the steps of:
executing a status analysis processing upon receiving a data operation for executing the status analysis processing from an input device of a computer system;
estimating a reorganization timing by using a result of the status analysis processing;
calculating a current storage status based on data operation information by storage status calculation processing;
comparing a current storage status estimated from the result of the status analysis processing and the current storage status calculated by the storage status calculation processing; and
displaying a reorganization timing or storage status re-estimated based on a result of the comparison on an output device according to an instruction from the input device.

4. A database reorganization timing estimation method for performing reorganization processing and status analysis processing, wherein the reorganization processing is performed according to a condition of use of database storage areas where data is stored to eliminate disturbances in the storage state of data caused by inserts and deletes performed on the storage areas, wherein the status analysis processing is performed to analyze a storage efficiency and the number of fragmented data to see how data is arranged in the storage areas; the database reorganization timing estimation method comprising the steps of:
preparing a storage status disturbance factor list containing storage status disturbance factors, such as a storage efficiency reduction and data fragmentations;
preparing a disturbance decision threshold list containing thresholds against which a magnitude of each of the disturbance factors is checked to determine if the reorganization processing is necessary;
preparing a warning output threshold list containing thresholds used to determine whether or not to issue a warning that there is a large difference between an actual storage state and an estimated storage state;
storing a result of the status analysis processing in a status analysis result log;
performing reorganization timing estimation processing to estimate a time when the disturbance decision threshold is exceeded, from a transition of the status analysis result log;
assuming, from a result of the reorganization timing estimation and the status analysis result log, a transition of a storage status value representing a storage state from when the status analysis was executed to a future point in time represented by the reorganization timing estimated result;
determining from the transition of the storage status value a storage status estimated value representing an estimate of a current storage status value when a data operation that modifies data in the storage areas is executed;
calculating an accumulated value of changes in the storage status value caused by data operations;
calculating a current storage status represented by the current storage status value from the status analysis result log and the accumulated value of changes; and
comparing the current storage status with the storage status estimated value and, when their ratio is in excess of the warning output threshold, executing the reorganization timing estimation again and outputting a corrected, estimated result.

5. A database reorganization timing estimation method according to claim 4, wherein, when the current storage status and the storage status estimated value are compared and their ratio is in excess of the warning output threshold, a warning is output.

6. A database reorganization timing estimation method for performing reorganization processing and status analysis processing, wherein the reorganization processing is performed according to a condition of use of data areas to eliminate disturbances in the storage state of data caused by inserts and deletes performed on the storage areas of database, wherein the status analysis processing is performed to analyze a storage efficiency and the number of fragmented data to see how data is arranged in the storage areas; the database reorganization timing estimation method comprising the steps of:
preparing a storage status disturbance factor list containing storage status disturbance factors, such as a storage efficiency reduction and data fragmentations; and
preparing a disturbance decision threshold list containing thresholds against which a magnitude of each of the disturbance factors is checked to determine if the reorganization processing is necessary;
performing the status analysis at the start of a database system and storing a result of the status analysis as an initial storage status;
calculating an accumulated value of changes in a storage status value caused by data operations, the data operations being executed to modify data in the storage areas;
calculating a current storage status represented by the current storage status value from the initial storage status and the accumulated value of changes; and
comparing the current storage status with the disturbance decision threshold list and, if the storage status requires reorganization, outputting a warning that the reorganization needs to be performed.

7. A database reorganization timing estimation method for performing reorganization processing and reorganization timing estimation processing, wherein the reorganization processing is performed according to a condition of use of data areas to eliminate disturbances in the storage state of data caused by inserts and deletes performed on the storage areas of database, wherein the reorganization timing estimation processing is performed to estimate a time when reorganization will become necessary; the database reorganization timing estimation method comprising the steps of:
storing as a storage status log a result of calculating a current storage status; and
estimating from the storage status log a time when the reorganization will become necessary.

8. A database reorganization timing estimation method for performing reorganization processing and reorganization timing estimation processing, wherein the reorganization processing is performed according to a condition of use of data areas to eliminate disturbances in the storage state of data caused by inserts and deletes performed on the storage areas of database, wherein the reorganization timing estimation processing is performed to estimate a time when reorganization will become necessary; the database reorganization timing estimation method comprising the steps of:
storing a time taken by an execution of the reorganization; and
subtracting the execution time from the estimated timing in the reorganization timing estimation processing.

9. A database reorganization timing estimation method according to claim 4, further comprising the steps of:
when the result of the reorganization timing estimation processing finds that a time period up to the estimated timing is greater than a threshold set by the user or system, displaying a point in time intermediate between the estimation execution point and the estimated timing as a status analysis execution recommended timing which indicates when the status analysis should be performed next; and
when a value representing a level of disturbance of the storage status sharply changes, performing a correction operation which advances the status analysis execution recommended timing by a magnitude inversely proportional to a steepness of the change.

10. A database reorganization timing estimation method according to claim 4, further comprising the steps of:
after executing the reorganization, nullifying the status analysis result log so that it will not be used for the estimation processing;
calculating, from the nullified log, a gradient of change in the value representing the level of disturbance of the storage status as a storage status transition log; and
if there is no valid status analysis result log immediately after the execution of the reorganization, performing the reorganization timing estimation processing by using the storage status transition log.
